(19) United States
(12) Patent Application Publication
(10) Pub. No.: US 2003/0007629 A1
(43) Pub. Date: Jan. 9, 2003

(54) Inlet splitting plane, high pass filter splitting plane, and main distribution frame

(75) Inventor: Minoru Unsai, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/187,970

(22) Filed: Jul. 3, 2002

(30) Foreign Application Priority Data
Jul. 5, 2001 (JP) 2001-204528

(51) Int. Cl. H04M 3/00; H04M 5/00

(52) U.S. Cl. 379/327; 379/331

(57) ABSTRACT

A main distribution frame (MDF) is provided for providing the user with ADSL services by simply making a slight modification to a conventional main distribution frame and performing an extremely simple wiring operation. An inlet splitting plane (ISP) and a high pass filter splitting plane are also provided which can be suitably used in the main distribution frame. The main distribution frame has an outlet splitting plane, the inlet splitting plane having a low pass filter, and a high pass filter splitting plane having a high pass filter. The outlet splitting plane is connected to supply its output to the inlet splitting plane and high pass filter splitting plane in parallel. The inlet splitting plane is connected to a telephone exchanger system, while the high pass filter splitting plane is connected to an ADSL system.

### BACKGROUND OF THE INVENTION

1. Field of the Invention

The present invention relates to a main distribution frame for connecting an existing telephone network to an ADSL (asymmetric digital subscriber line) system, and more particularly, to a main distribution frame which can provide users with an ADSL service only with a slight modification added to an existing main distribution frame and a quite simple wiring operation, and an inlet splitting plane and a high pass filter splitting plane which are suitable for use in the main distribution frame.

2. Description of the Related Art

ADSL-based network connection services have rapidly spread in recent years. For providing this type of services to users, a main distribution frame (MDF) in a conventional telephone communication system must be modified to permit a connection to an ADSL system.

FIG. 1 illustrates a conventional telephone network. As illustrated in FIG. 1, in a conventional telephone communication system, outlet splitting plane (OSP) 1 of MDF is connected to telephone terminal 101; inlet splitting plane (ISP) 2′ is connected to telephone exchanger (plain old telephone service: POTS) 6; and 11a of OSP 1 is connected to 21b of ISP 2′ with a jumper line to establish a connection to a line.

For providing an ADSL service, the MDF must be connected to POTS system 6 when the user makes a telephone communication, and connected to ADSL system 5 when the user makes an ADSL communication. In other words, the MDF is required to have a function of transmitting a telephone communication signal (POTS signal) to POTS system 6 and an ADSL signal to ADSL system 5.

To meet this requirement, conventionally, the system illustrated in FIG. 1 has been modified as illustrated in FIG. 2 to provide the user with ADSL services.

An MDF illustrated in FIG. 2 comprises inlet splitter module relay splitting plane (SPM-IN) 8′ and outlet splitter module relay splitting plane (SPM-OUT) 9, in addition to OSP1 and ISP 2′, for connection with splitter module (SPM) 7 connected to ADSL system 5.

The MDF receives a composite signal of a POTS signal and an ADSL signal from POTS splitter 102. POTS splitter 102 in turn combines the ADSL signal from PC 100, which is an ADSL terminal, with the POTS signal from TEL 101, which is a telephone terminal, and supplies the composite signal to the MDF.

The MDF receives the composite signal at OSP 1. Here, a signal from a user who has concluded an ADSL service contract is not fed directly to ISP 2′ but to SPM-IN 8′. Then, SPM-IN 8′ supplies this signal to SPM 7.

SPM 7 has POTS splitter card 3′. POTS splitter card 3′ has a low pass filter (LPF) and a high pass filter (HPF) to classify (distribute) signals from the user into the POTS signal and ADSL signal.

The ADSL signal cannot pass through the LPF but passes through the HPF since it is a signal in a high frequency band which is not used by the POTS signal (conventional telephone communications). Conversely, the POTS signal passes through the LPF but does not pass through the HPF. In other words, the ADSL signal is delivered from output terminal 71a″ and fed to ADSL system 5. The POTS signal in turn is delivered from output terminal 71a′ and fed to SPM-OUT 9.

SPM-OUT 9 supplies ISP 2′ with the signal fed thereto from SPM 7, i.e., the POTS signal. ISP 2′ transmits the POTS signal to POTS system 6.

In this way, the ADSL signal from the user is transmitted to ADSL system 5, and the POTS signal to POTS system 6, respectively.

A signal from POTS system 6 or ADSL system 5 to the user is fed to splitter 102 through the flow reverse to the foregoing. Splitter 102 supplies an ADSL signal to ADSL terminal 100, and a POTS signal to telephone terminal 101.

Thus, in the prior art, an MDF manager must add three components, i.e., SPM-IN 8′, SPM-OUT 9 and SPM 7 to the conventional communication system illustrated in FIG. 2, and also perform a complicated wiring operation for connecting the conventional system to the new components and ADSL system 5.

While OSP 1 is directly connected to ISP 2′ in the conventional audio communication system illustrated in FIG. 1, OSP 1 is connected to ISP 2′ through SPM-IN 8′, SPM 7 and SPM-OUT 9 in the system illustrated in FIG. 2.

More specifically, the following operations must be performed:

(1) the destination of U-slit terminal 11a of OSP 1 is changed from jumper connection U-slit terminal 21b of ISP 2′ to jumper connection U-slit terminal 81a of SPM-IN 8′;

(2) U-slit terminal 81a′ of SPM-IN 8′ is connected to POTS connection terminal 71a of SPM 7;

(3) output terminal 71a″ from HPF of SPM 7 is connected to ADSL system 5;

(4) output terminal 71a′ from LPF of SPM 7 is connected to U-slit terminal 91a′ of SPM-OUT 9; and

(5) jumper connection U-slit terminal 91a of SPM-OUT 9 is connected to jumper connection U-slit terminal 21a of ISP 2′.

Because of the requirements for such complicated modification and wiring operations, an extremely long time is taken until user can receive ADSL services.

### SUMMARY OF THE INVENTION

The present invention has been made in view of the foregoing problem, and it is an object of the invention to provide a main distribution frame which is capable of providing the user with ADSL services by simply making a slight modification to a conventional main distribution frame (MDF) and performing a quite simple wiring operation.

It is another object of the present invention to provide an inlet splitting plane (ISP) and a high pass filter splitting plane which are suitable for use in the main distribution frame.

To achieve the above objects, an inlet splitting plane for use in a main distribution frame of the present invention has a low pass filter for extracting a telephone communication signal.

Additionally, the main distribution frame may have the low pass filter coupled between breaker connectors.

A high pass filter splitting plane for use in the main distribution frame of the present invention has a high pass filter for extracting an ADSL (asymmetric digital subscriber line) signal.

Additionally, the high pass filter splitting plane may have a first U-slit terminal for direct or indirect connection with an outlet splitting plane of the main distribution frame, a second U-slit terminal for connection with an ADSL system, and two breaker connectors disposed between the first and second U-slit terminals, and may also have the high pass filter coupled between the breaker connectors.

A main distribution frame of the present invention has an outlet splitting plane, the aforementioned inlet splitting plane, and the aforementioned high pass filter splitting plane, wherein the outlet splitting plane is connected to supply its output to the inlet splitting plane and high pass filter splitting plane in parallel, the inlet splitting plane is connected to a telephone exchanger system, and the high pass filter splitting plane is connected to an ADSL system.

A main distribution frame of the present invention has an outlet splitting plane, and the aforementioned inlet splitting plane, wherein the outlet splitting plane is connected to supply its output in parallel to the inlet splitting plane and the aforementioned high pass filter splitting plane disposed external to the main distribution frame for connection with an ADSL system, and the inlet splitting plane is connected to a telephone exchanger system.

According to the present invention, the HPF splitting plane is newly added to a conventional MDF, the outlet splitting plane (OSP) is connected to the HPF splitting plane and inlet splitting plane (ISP), an HPF card is mounted on the HPF splitting plane, and an LPF is mounted on the ISP. The HPF splitting plane is connected to an ADSL system. In this way, ADSL services can be provided to the user without changing cables and jumper pins in a conventional system (POTS signal system). In other words, an ADSL service providing system can be built without changing the wiring in a conventional system by simply connecting the HPF splitting plane to the OSP by jumper lines for connection with a newly added ADSL system.

### BRIEF DESCRIPTION OF THE DRAWINGS

FIG. 1 illustrates an exemplary configuration of a conventional MDF;

FIG. 2 is a diagram for explaining an exemplary connection to a conventional ADSL system;

FIG. 3 is a diagram for explaining an exemplary configuration of an MDF according to the present invention;

FIG. 4 illustrates an exemplary circuit configuration of an LPF card in the MDF of FIG. 3;

FIG. 5 illustrates an exemplary circuit configuration of an HPF card in the MDF of FIG. 3;

FIG. 6 illustrates a second exemplary configuration of the MDF according to the present invention; and

FIG. 7 illustrates a third exemplary configuration of the MDF according to the present invention.

### DETAILED DESCRIPTION OF THE PREFERRED EMBODIMENTS

In the following, a main distribution frame, a inlet splitting plane and a high pass filter splitting plane according to the present invention will be described in detail in connection with several embodiments. The following description will focus on the main distribution frame, together with additional description on the inlet splitting plane and high pass filter splitting plane.

The main distribution frame (MDF) according to the present invention supplies a composite signal of an audio signal (POTS signal) and a data signal (high frequency ADSL signal) fed from the user to the inlet splitting plane (ISP) having a low pass filter (LPF) and to the high pass filter splitting plane (HPF splitting plane) having a high pass filter (HPF). The ISP passes the composite signal through the LPF to extract the POTS signal which is supplied to a telephone exchanger system (POTS system). The HPF splitting plane passes the composite signal through the HPF to extract the ADSL signal which is supplied to an ADSL system.

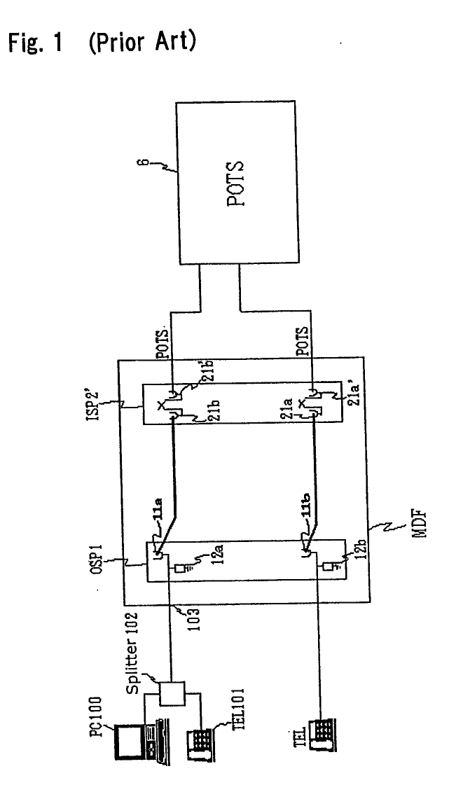

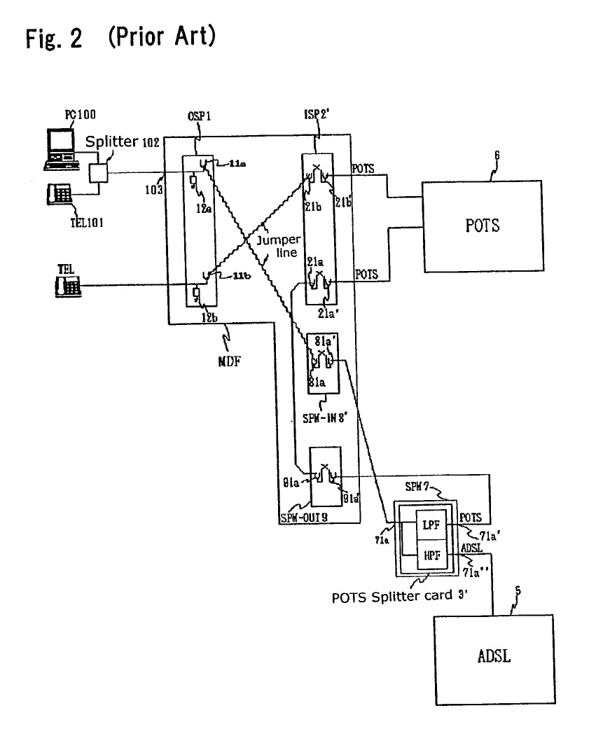

Specifically, ADSL services can be provided to the user by simply installing an LPF in the ISP of the conventional MDF illustrated in FIG. 1 and an HPF splitting plane at a position parallel with the ISP for an input signal from the user, and wiring the outlet splitting plane (OSP) to connect both to the ISP and to the HPF splitting plane.

In the following, an example which suitably embodies this MDF will be described in detail with reference to the accompanying drawings.

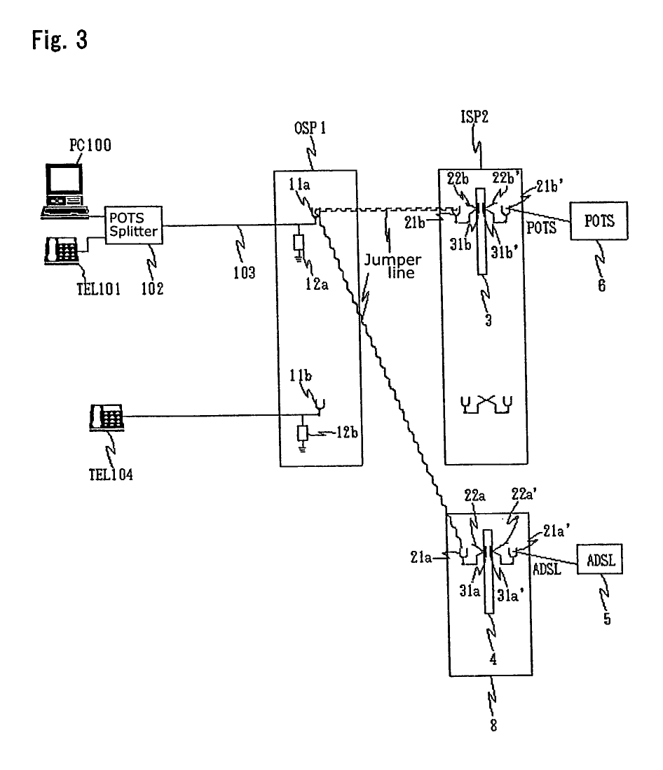

FIG. 3 illustrates an exemplary internal configuration of the MDF. The MDF is installed between subscriber terminals (PC 100, TEL 101) and telephone exchanger 6, in a manner similar to the prior art, and has OSP 1, ISP 2, and HPF splitting plane 8.

OSP 1

The same one as the OSP employed in the conventional MDF, or an equivalent thereto may be employed for OSP 1 which comprises protection circuit 12 and U-slit terminal 11, as illustrated in FIG. 3.

ISP 2

An ISP employed in the conventional MDF with an additional LPF (LPF card) is employed for ISP 2 which connects OSP 1 (subscriber terminal) to POTS system 6. The LPF may be any filter which can extract a POTS signal from a composite signal of the POTS signal and ADSL signal. In other words, any filter may be used as long as it can filter out signals in a band used for the ADSL signal. Know filters can be employed for such a filter.

As illustrated in FIG. 3, ISP 2 is connected to OSP 1 through U-slit terminal 21b, and to POTS system 6 through U-slit terminal 21b. ISP 2 has breaker connectors 22b, 22b′ between U-slit terminals 21b and 21b′. The LPF (LPF card 3) may be disposed between breaker connectors 22b and 22b′.

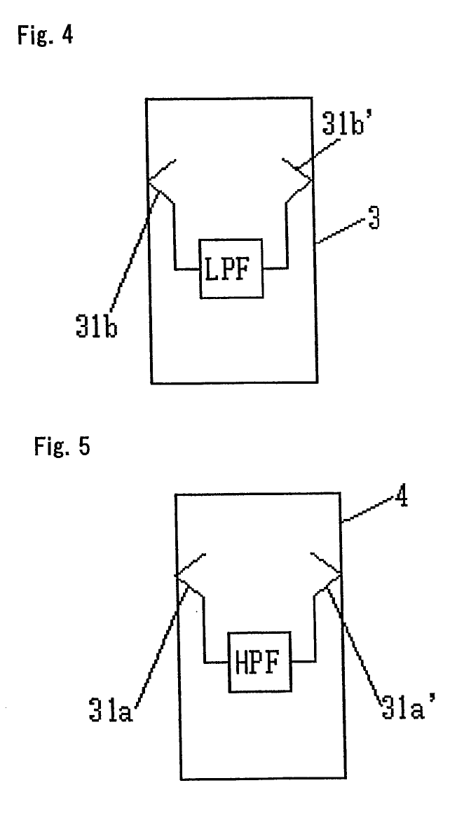

FIG. 4 illustrates an exemplary circuit configuration of LPF card 3. As illustrated in FIG. 4, LPF card 3 has the LPF connected to input terminal (LPF card connection terminal) 31b and to output terminal (LPF card connection terminal) 31b′. LPF card connection terminal 31b is connected to U-slit terminal 21b of OSP 1, while output terminal 31b ′is connected to U-slit terminal 21b′ of POTS system 6.

HPF Splitting Plane 8

HPF splitting plane 8 has an HPF and is connected to ADSL system 5. HPF splitting plane 8 has U-slit terminals 21a, 21a′; breaker connectors 22a, 22a′; and HPF card 4. The HPF may be any filter which can extract an ADSL signal from a composite signal of a POTS signal and the ADSL signal. In other words, the HPF may be a filter which can filter out signals in a band used for the POTS signal. Known filters can be employed for such a filter.

As illustrated in FIG. 3, HPF splitting plane 8 is connected to OSP 1 through U-slit terminal 21a, and to ADSL system 5 through U-slit terminal 21a′. HPF splitting plane 8 has breaker connectors 22a, 22a′ between U-slit terminals 21a and 21a′. The HPF (HPF card 4) may be disposed between breaker connectors 22a and 22a′.

FIG. 5 illustrates an exemplary circuit configuration of HPF card 4. As illustrated in FIG. 5, HPF card 4 has an HPF and HPF card connection terminals 31a, 31a′. HPF card connection terminal 31a is connected to breaker connector 22a which is connected to U-slit terminal 21a, while HPF card connection terminal 31a′ is connected to breaker connector 22a′ which is connected to U-slit terminal 21a′, respectively.

Wiring

OSP 1 (U-slit terminal 11a) is wired such that its output can be supplied to ISP 2 and HPF splitting plane 8. In other words, ISP 2 and HPF splitting plane 8 are connected in parallel with this output.

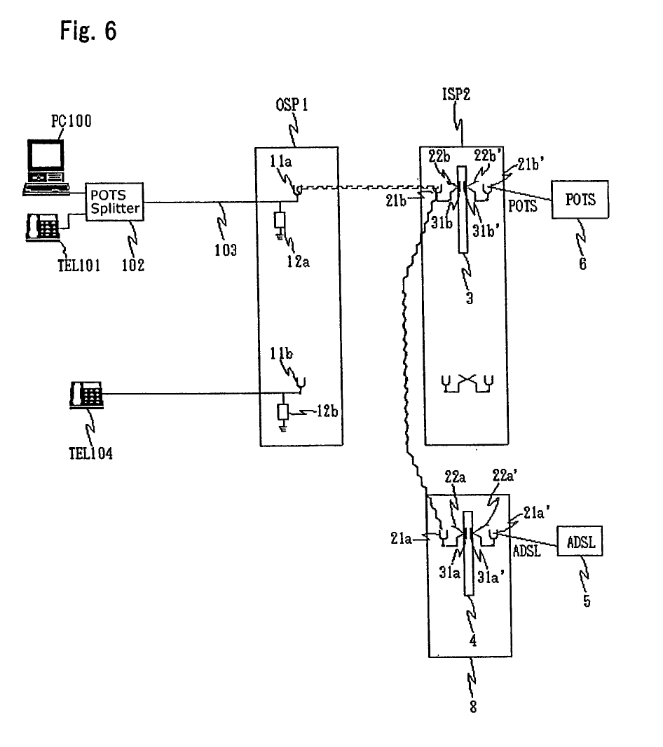

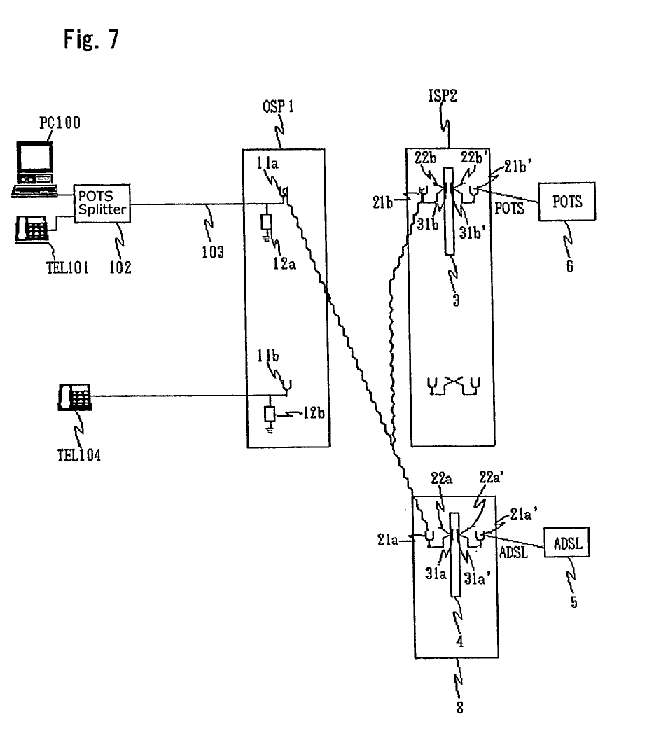

Therefore, as illustrated in FIG. 3, U-slit terminal 11a may be connected to U-slit terminal 21a, 21b, respectively, by jumper lines. Alternatively, as illustrated in FIGS. 6, 7, U-slit terminal 11a may be connected to either of U-slit terminals 21a, 21b by a jumper line, with U-slit terminals 21a, 21b connected to each other.

Also, as described above, U-slit terminal 21b′ of ISP 2 is connected to POTS system 6 by a POTS signal cable, while U-slit terminal 21a′ of HPF splitting plane 8 is connected to ADSL system 5 by an ADSL signal cable.

Exemplary Operation/Control

POTS splitter 102 supplies OSP 1 with a composite signal of a POTS signal generated by TEL 101 (telephone terminal) and an ADSL signal generated by PC 100 (ADSL terminal) through telephone line 103. OSP 1 supplies this composite signal to ISP 2 and HPF splitting plane 8.

Specifically, the composite signal, once fed to OSP 1, is delivered to U-slit terminal 11a through temporary protection circuit 12a. Then, the composite signal is supplied to U-slit terminal 21b of ISP 2 connected to OSP 1 by a jumper line and U-slit terminal 21a of HPF splitting plane 8 connected to OSP 1 by a jumper line.

ISP 2 uses LPF card 3 to extract the POTS signal from the composite signal which is supplied to POTS system 6.

ISP 2 supplies LPF card 3 with the composite signal supplied to U-slit terminal 21b from OSP 1 through breaker terminal 22b. Upon receipt of the composite signal at input terminal 31b, LPF card 3 passes it to the LPF. The LPF extracts a signal in a band lower than a predetermined band from the composite signal. Specifically, the LPF extracts the POTS signal. The extracted POTS signal is fed from output terminal 31b to breaker terminal 22b′. The composite signal fed to breaker terminal 22b′ is supplied to POTS system 6 from U-slit terminal 21b′ through POTS cable.

HPF splitting plane 8 uses HPF card 4 to extract the ADSL signal from the composite signal which is supplied to ADSL system 5.

HPF splitting plane 8 supplies HPF card 4 with the composite signal fed to U-slit terminal 21a from OSP 1 through breaker terminal 22a. Upon receipt of the composite signal at input terminal 31a, HPF card 4 passes it to the HPF for extracting a signal in a band higher than a predetermined band. Specifically, the HPF extracts the ADSL signal. The extracted ADSL signal is fed from output terminal 31a′ to breaker terminal 22a. The composite signal fed to breaker terminal 22a′ is supplied to ADSL system 5 from U-slit terminal 21a′ through an ADSL cable.

The ADSL signal from ADSL system 5 and the POTS signal from POTS system 6 reach the subscriber terminals (TEL 101, PC terminal 100), respectively, through the aforementioned signal transfer path in the reverse order.

The POTS signal delivered from POTS system 6 to TEL 101 is supplied to ISP 2 of the MDF. Though ISP 2 has the LPF, the POTS signal passes through ISP 2 since it can pass through the LPF as described above. After passing through ISP 2, the POTS signal is supplied to POTS splitter 102 through OSP 1. POTS splitter 102 supplies the incoming POTS signal to TEL 101 in a known method.

The ADSL signal delivered from ADSL system 5 to PC 100 is supplied to HPF splitting plane 8 of the MDF. Though HPF splitting plane 8 has the HPF, the ADSL signal passes through the HPF splitting plane 8 since it can pass through the HPF. After passing through HPF splitting plane 8, the ADSL signal is supplied to POTS splitter 102 through OSP 1. POTS splitter 102 supplies the incoming ADSL signal to PC 100 in a known method.

While a preferred embodiment of the present invention has been described above, the foregoing embodiment is a mere illustration for explaining the invention and is not intended to limit the scope of the invention only to this embodiment. Those skilled in the art can also practice the present invention in a variety of implementations by making a variety of variations, improvements, modifications, simplifications and the like to the foregoing embodiment.

For example, HPF splitting plane 8 may be disposed between the MDF and ADSL system 5, or within ADSL system 5. When HPF splitting plane 8 is disposed external to the MDF in this manner, an existing MDF can provide ADSL services to the user by simply adding an LPF to ISP 2 and connecting externally disposed HPF splitting plane 8 to OSP 1.

What is claimed is:

1. An inlet splitting plane for a main distribution frame, comprising:
a low pass filter which permits a telephone communication signal to pass therethrough and does not permit an ADSL (asymmetric digital subscriber line) signal to pass therethrough.

2. The inlet splitting plane for a main distribution frame according to claim 1, further comprising breaker connectors between which said low pass filter is disposed.

3. A high pass filter splitting plane for a main distribution frame, comprising:
a high pass filter which permits an ADSL (asymmetric digital subscriber line) signal to pass therethrough and does not permit a telephone communication signal to pass therethrough.

4. The high pass filter splitting plane for a main distribution frame according to claim 3, further comprising:
a first U-slit terminal for direct or indirect connection with an outlet splitting plane of said main distribution frame;
a second U-slit terminal for connection with an ADSL system; and
two breaker connectors disposed between said first and second U-slit terminals,
wherein said high pass filter is disposed between said two breaker connectors.

5. A main distribution frame comprising:
an outlet splitting plane;
an inlet splitting plane according to claim 1; and
a high pas filter splitting plane according to claim 3,
wherein said outlet splitting plane is connected to supply an output therefrom to said inlet splitting plane and said high pass filter splitting plane in parallel,
said inlet splitting plane is connected to a telephone exchanger system, and
said high pass filter splitting plane is connected to an ADSL system.

6. A main distribution frame comprising:
an outlet splitting plane;
an inlet splitting plane according to claim 1; and
a high pas filter splitting plane according to claim 4,
wherein said outlet splitting plane is connected to supply an output therefrom to said inlet splitting plane and said high pass filter splitting plane in parallel,
said inlet splitting plane is connected to a telephone exchanger system, and
said high pass filter splitting plane is connected to an ADSL system.

7. A main distribution frame comprising:
an outlet splitting plane;
an inlet splitting plane according to claim 2; and
a high pas filter splitting plane according to claim 3,
wherein said outlet splitting plane is connected to supply an output therefrom to said inlet splitting plane and said high pass filter splitting plane in parallel,
said inlet splitting plane is connected to a telephone exchanger system, and
said high pass filter splitting plane is connected to an ADSL system.

8. A main distribution frame comprising:
an outlet splitting plane;
an inlet splitting plane according to claim 2; and
a high pas filter splitting plane according to claim 4,
wherein said outlet splitting plane is connected to supply an output therefrom to said inlet splitting plane and said high pass filter splitting plane in parallel,
said inlet splitting plane is connected to a telephone exchanger system, and
said high pass filter splitting plane is connected to an ADSL system.

9. A main distribution frame comprising:
an outlet splitting plane; and
an inlet splitting plane according to claim 1,
wherein said outlet splitting plane is connected to supply an output therefrom in parallel to said inlet splitting plane and a high pass filter splitting plane according to claim 3 disposed external to said main distribution frame for connection with an ADSL system, and
said inlet splitting plane is connected to a telephone exchanger system.

10. A main distribution frame comprising:
an outlet splitting plane; and
an inlet splitting plane according to claim 1,
wherein said outlet splitting plane is connected to supply an output therefrom in parallel to said inlet splitting plane and a high pass filter splitting plane according to claim 4 disposed external to said main distribution frame for connection with an ADSL system, and
said inlet splitting plane is connected to a telephone exchanger system.

11. A main distribution frame comprising:
an outlet splitting plane; and
an inlet splitting plane according to claim 2,
wherein said outlet splitting plane is connected to supply an output therefrom in parallel to said inlet splitting plane and a high pass filter splitting plane according to claim 3 disposed external to said main distribution frame for connection with an ADSL system, and
said inlet splitting plane is connected to a telephone exchanger system.

12. A main distribution frame comprising:
an outlet splitting plane; and
an inlet splitting plane according to claim 2,
wherein said outlet splitting plane is connected to supply an output therefrom in parallel to said inlet splitting plane and a high pass filter splitting plane according to claim 4 disposed external to said main distribution frame for connection with an ADSL system, and
said inlet splitting plane is connected to a telephone exchanger system.
